(19) United States
(12) Patent Application Publication
(10) Pub. No.: US 2024/0251772 A1
(43) Pub. Date: Aug. 1, 2024

(54) One Hand Auto Fishing Device

(71) Applicant: Joseph Cooke, Los Lunas, NM (US)

(72) Inventor: Joseph Cooke, Los Lunas, NM (US)

(21) Appl. No.: 18/103,610

(22) Filed: Jan. 31, 2023

(51) Int. Cl. A01K 97/11; A01K 89/015

(52) U.S. Cl. CPC A01K 97/11; A01K 89/01902

(57) ABSTRACT

The One Handed Auto Fishing Pole for the Disabled is the only product of its kind that is specifically developed for individuals who are only able to use one hand while fishing due to injury and/or physical impairment as it provides a go-to-tool that simplifies rod functionality via power control features. This unprecedented product is uniquely designed with durable, high-quality materials to ensure long term sustainability and can cater to a targeted consumer based who enjoys fishing excursions; yet, are limited in adequate supplies suitable for their own utilization.

### BACKGROUND

Individuals who may have suffered a stroke and/or have lost the full use of one side of their body, actively participating in fishing sporting activities may be incredibly difficult especially with the use of current equipment on the market. Traditional poles and reels are created for individuals that are capable of using both of their hands, creating a struggle for others with a disability, to effectively maneuver the accessories. There have been no products available as original equipment or as an aftermarket to address this problem.

An apparatus to assist disabled individuals so they may enjoy fishing activities is not being met by any known device or system at present. There have been no products available as original equipment or as an aftermarket to address this problem either.

### SUMMARY OF THE INVENTION

The main purpose of the one-hand fishing device is to provide users with adaptive fishing equipment for the physically challenged.

A fishing rod and reel device including a worm gear motor engaged with the reel, a momentary push button switch configured to start the worm gear motor, a release switch configured to stop the worm gear motor and let the reel turn freely for casting, a handle portion of the fishing rod comprising a direct current battery compartment, and power and control wires running inside the fishing rod between the worm gear motor, the buttons and the battery compartment.

### BRIEF DESCRIPTION OF THE DRAWINGS

FIG. 1 is a top perspective view of the one-hand fishing device in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

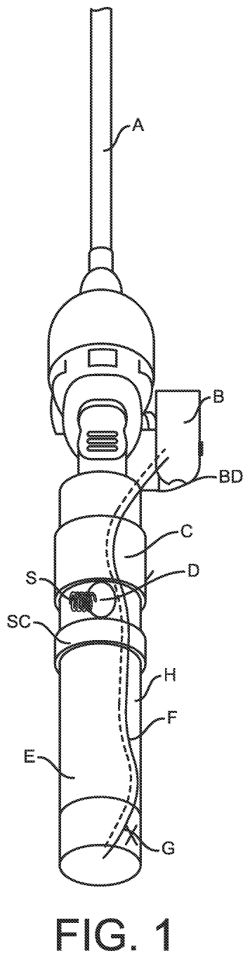

FIG. 1 is a top perspective view of the one-hand fishing device showing: Shakespeare rod and reel referenced as A, 120 RPM 3-6 volt worm gear motor referenced as B, ¾″ schedule 40 PBC reducer referenced as C, momentary push button switch referenced as D, the release button spring S, the battery compartment referenced as E, push button power and control wires (positive and negative and control signals) referenced as F, screw-on-cap referenced as G, 1″ schedule 40 PVC pipe referenced as H, in accordance with an embodiment of the present disclosure.

In an embodiment, a optional switch cover SC is concentric with the fishing rod and slides over the momentary push button switch D to protect it from depression when not needed. The brake and delay component BD is engineered to brake the free turn of the reel and the start of the worm gear motor. It is a mechanical brake in some embodiments and an electrical brake in other embodiments. In fact it can also be as simple as a depressive pad on the worm gear motor. The brake and delay functions protects the worm gear motor from engagement with the reel while it is still in casting motions. The delay component is configured to provide a predetermined time for a coasting stop of the free turn of the reel a predetermined time to another or subsequent start of the worm gear motor.

The present disclosed one-hand fishing device, also known as the “One Handed Auto Fishing Pole for the Disabled/Physically Impaired,” offers a modern alternative device that provides a method for physically challenged individuals to use a fishing pole; thus, ensuring they are able to enjoy the sport to its fullest potential. Expanding on the initial design of an average fishing pole, the One Handed Auto Fishing Pole for the Disabled introduces a novel fishing pool/reel that allows full use of the product with sole control managed by one hand as it employs a USB (universal serial bus) rechargeable battery powered motor able to function based on button commands, permitting physically challenged individuals to fish like everyone else, without struggling to direct the rod in effort to ensure the best catch. This innovative, top-quality product ensures a fully operational fishing pole and rod for those who seek to fish again with the use of one arm.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A fishing rod and reel device comprising:
a worm gear motor engaged with the reel;
a momentary push button switch configured to start the worm gear motor;
a release switch configured to stop the worm gear motor and let the reel turn freely for casting;
a handle portion of the fishing rod comprising a direct current battery compartment; and
a plurality of power and control wires running inside the fishing rod between the worm gear motor, the buttons and the battery compartment.

2. The fishing rod and reel device of claim 1, wherein the release switch is a spring release component of the momentary push button switch.

3. The fishing rod and reel device of claim 1, wherein the worm gear is a 3-6 bolt worm gear.

4. The fishing rod and reel device of claim 1, wherein the worm gear motor is a direct current brushless motor.

5. The fishing rod and reel device of claim 1, further comprising a handle for the fishing pole device comprising a ¼″-¾″ schedule 40 PVC (polyvinyl chloride) reducer segment.

6. The fishing rod and reel device of claim 1, wherein the handle portion of the fishing rod comprises 1″ schedule 40 PVC pipe.

7. The fishing rod and reel device of claim 1, wherein the release switch is disposed as a thumb button switch on the handle portion.

8. The fishing rod and reel device of claim 1, wherein the momentary push button switch is disposed on a finger portion of the handle portion.

9. The fishing rod and reel device of claim 1, further comprising a screw on cap on an end of the handle portion and configured to enable an insertion of batteries therein.

10. The fishing rod and reel device of claim 1, further comprising a concentric sliding cover for the momentary push button switch and the release switch.

11. The fishing rod and reel device of claim 1, wherein the momentary push button switch starts the worm gear motor and a subsequent push of the button stops the worm gear motor.

12. The fishing rod and reel device of claim 1, wherein a depression of the momentary push button switch starts the worm gear motor and a release of the momentary push button switch stops the worm gear motor.

13. The fishing rod and reel device of claim 1, wherein the release switch is activated by a release of the momentary push button switch.

14. The fishing rod and reel device of claim 1, further comprising a brake component configured to brake the free turn of the reel and the start of the worm gear motor.

15. The fishing rod and reel device of claim 1, further comprising a delay component configured to coast the free turn of the reel a predetermined time to the start of the worm gear motor.
